(19) United States
(12) Patent Application Publication
(10) Pub. No.: US 2014/0080525 A1
(43) Pub. Date: Mar. 20, 2014

(54) SYSTEM AND METHOD FOR ELECTRONIC TEXT COMMUNICATION

(71) Applicant: INTUIT INC., (US)

(72) Inventors: Gopi Krishnan Nambiar, Bangalore (IN); Srividhya Ramarathnam, Bangalore (IN); Vankatesh B. Neldurg, Bangalore (IN); Gaurav Bhatia, Bangalore (IN)

(73) Assignee: INTUIT INC., Mountain View, CA (US)

(21) Appl. No.: 13/622,250

(22) Filed: Sep. 18, 2012

(51) Int. Cl. H04W 4/14

(52) U.S. Cl. 455/466

(57) ABSTRACT

A system and method for electronic text communication in an environment in which SMS (Short Messaging Service) messages, MMS (Multimedia Messaging Service) messages and/or other messages are delivered with a non-actionable reply-to field. Illustratively, a regulation may require the field to be alphabetic or alphanumeric, thereby preventing it from simply being a telephone number to which a response can be transmitted. Therefore, when an organization generates a message, it includes its address in the body of the message (e.g., at the top and/or bottom). Although the user cannot respond directly to the reply-to field, he easily finds a telephone number to which a reply can be sent. A user may be advised of terms of service of a text-based service, and may be given a summary of the terms, before being deemed to have opted in to the service.

### BACKGROUND

This invention relates to the field of electronic communications. More particularly, a system and methods are provided for supporting electronic text communications when they must be delivered to a user with a non-functional sender identification (or reply-to) field.

### SUMMARY

In some embodiments of the invention, a system and methods are provided for electronic text communication with a user, wherein a message (e.g., an SMS (or Short Messaging Service) text message) cannot be delivered with a usable or actionable reply-to field.

In particular, the reply-to field (or the sender identification or other similar field) of a message to a user may be restricted to alphabetic or alphanumeric content, because of applicable regulations or for some other reason. Therefore, it cannot simply consist of a telephone number to which the user can send a reply or a new message. The reply-to field value may be descriptive of the source of the message, but it does not help the user send a communication to the originator.

In these embodiments of the invention, an address (or telephone number) of the originator of the message is inserted into a body of the message to the user (e.g., at the head, at the foot). The user therefore does not need to search for a valid address. The address that is inserted will be compatible with the user's telephone service provider, location and/or indicated preferences.

Also, if the user has not yet opted-in to a service agreement (or terms of service) regarding services provided by the originator of electronic text messages, a notice regarding opting-in may be added to a message sent to that user. This may be followed up with a summary of the service agreement. Thereafter, if the user sends another request or response to the originator, he or she may be deemed to have opted-in. Delivery of the service agreement or terms of service may be tracked, and they may be re-sent if necessary.

### DESCRIPTION OF THE FIGURES

FIGS. 1A-B are block diagrams depicting the exchange of electronic text messages in which a reply-to field can consist of an actionable value.

FIG. 2 is a block diagram demonstrating an electronic message in which a reply-to field is restricted and non-actionable, according to some embodiments of the invention.

FIG. 3 is a block diagram demonstrating an electronic text message delivered with a non-actionable reply-to value, according to some embodiments of the invention.

FIG. 4 is a block diagram demonstrating another electronic text. message delivered with a non-actionable reply-to value, and also with summary terms of service, according to some embodiments of the invention.

FIG. 5 is a flow chart demonstrating a method of exchanging electronic text communications with a user, according to some embodiments of the invention.

FIG. 6 is a block diagram of a system for exchanging electronic text communications with a user, according to some embodiments of the invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In some embodiments of the invention, a system and methods are provided for supporting electronic communications via SMS (Short Messaging Service), MMS (Multimedia Messaging Service) and/or other formats or specifications. For example, an embodiment may be implemented with a text-based information service that transmits information to users' (or recipients') telephones via SMS text messages. The term “text message” is used herein to refer to any message that may be sent according to an embodiment of the invention described herein, even if the message does not contain text or does not contain only text.

Embodiments of the invention are suited for communication environments in which laws, regulations and/or third-party operating procedures restrict how a message may be delivered or how a sender of a message may be identified. A provider of information services, or other organization wishing to send electronic communications, may not be able to control these aspects of the messaging process.

For example, telecommunications regulations, business rules and/or other restrictions may specify that a text message be delivered with a sender identification field, reply-to field or other field configured to identify the originator of the message, but in a manner that makes the information non-actionable. Whereas the text message may normally have been delivered with an actionable value (e.g., before the applicable regulations took effect), now it cannot.

For purposes of describing these embodiments of the invention, the contents of the reply-to field or a similar field are considered actionable if they contain an address or value that a user (e.g., a recipient of the message) can respond to. For example, an actionable value in the reply-to field of an SMS text message may consist of a telephone number to which a user may direct a response (or an entirely new message) that will reach the originator of the text message.

The terms “reply-to field” and “sender identification” are used herein to refer to a field or message portion configured to identify the originator of a message, the content of which may be restricted as discussed herein.

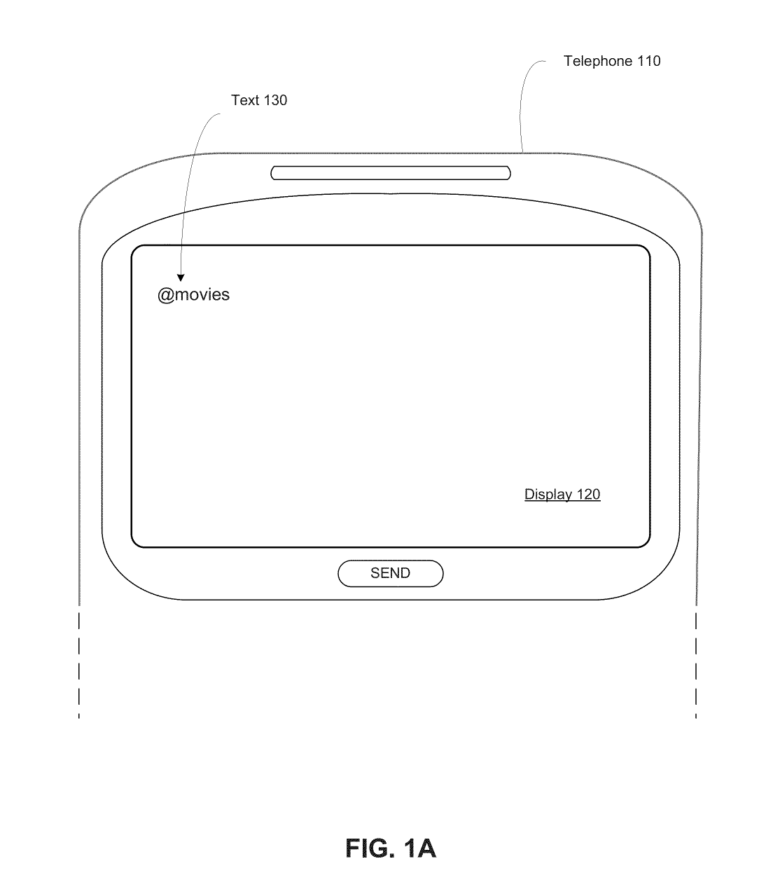

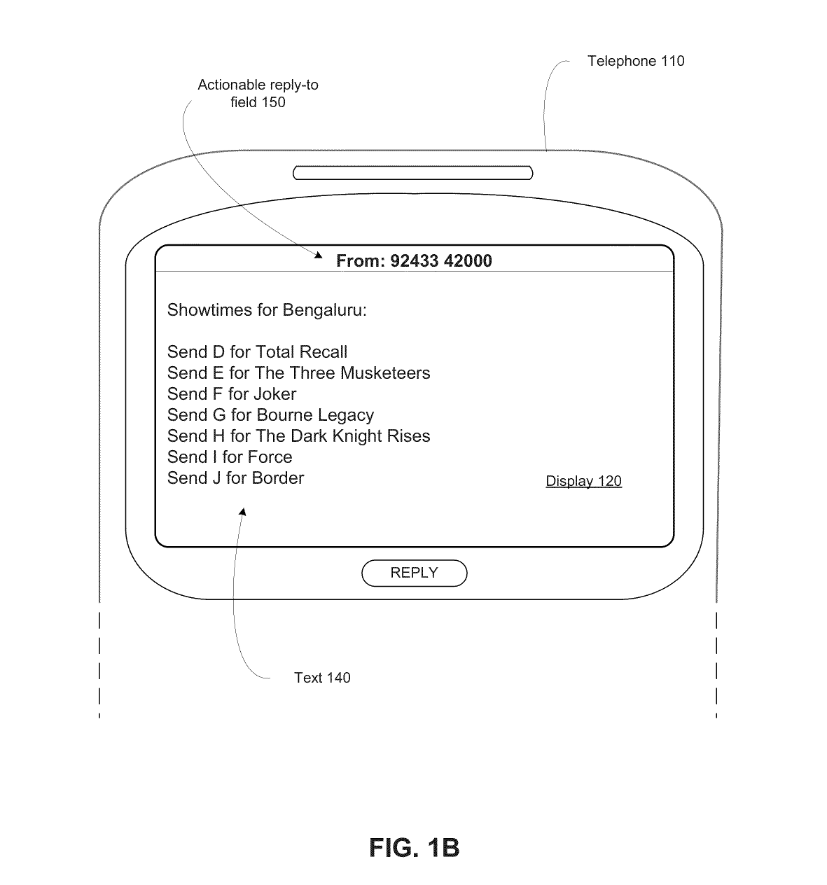

FIGS. 1A-B are block diagrams demonstrating an exchange of text messages between a user and an organization that issues text messages to users (e.g., an information service provider), in the absence of a regulation or rule that restricts the content of the reply-to field.

In FIG. 1A, a user of telephone 110 enters text 130 of a text message with a keypad (not shown), and it is printed on display 120. The user typically presses a Send button or soft-key when the message is complete, at which time the message is transmitted to the specified destination via the user's aggregator or telephone service provider (e.g., Sprint®, AT&T®, ValueFirst, Unicel).

In this example, the user is texting a request to a text-based information server or service, such as txtWeb (http://www.txtweb.com). The request comprises the text “@movies,” which the service may interpret as a request for a movie schedule.

FIG. 1B is an illustrative reply to the user's request. Text 140 of the response is presented in display 120, and reply-to field 150 is configured to identify a sender of the message. The content of the reply-to field includes an address (e.g., a telephone number) to which the user receiving the message can reply. The actionable value in field 150 saves the user the trouble of having to find a valid number for the issuer of the message shown in FIG. 1B.

When an originator of a text message to a user, or an entity responsible for delivering the message to the user, must use a non-actionable sender identification (or reply-to field), in some embodiments of the invention a telephone number or other address of the originator is inserted into the body of the message.

In some implementations, the address is placed at the beginning and/or end of the message; in other implementations it is placed elsewhere. For example, it may be inserted at regular offsets within the message, so that as a recipient scrolls through or pages-down the message, the address is always or regularly viewable.

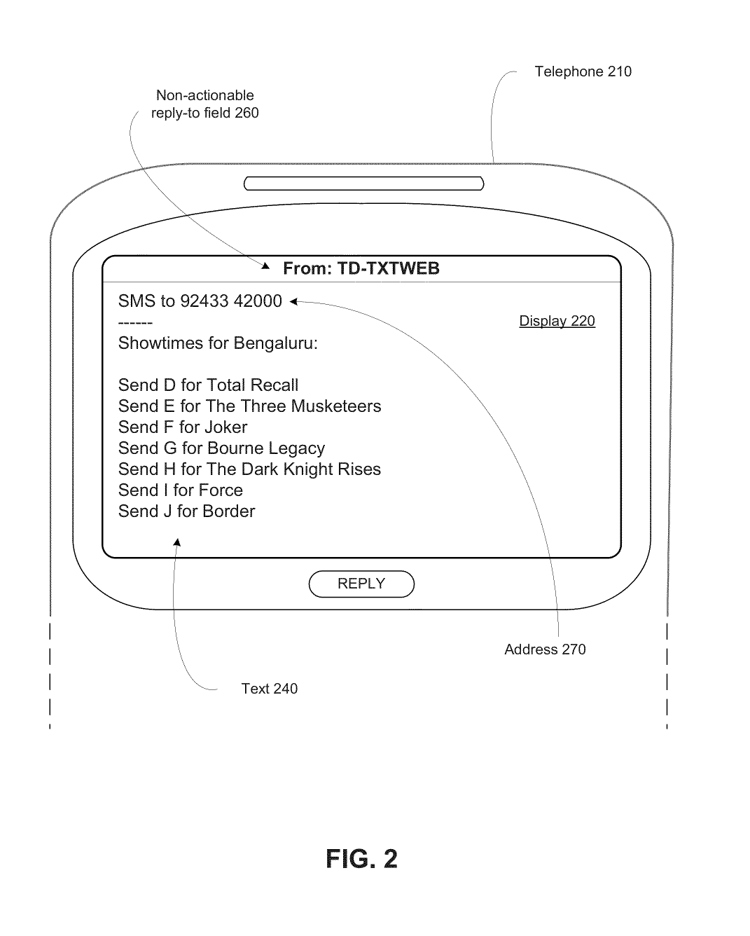

FIG. 2 is a block diagram illustrating a text message delivered to a user with a non-actionable reply-to field, according to some embodiments of the invention.

Text 240 of the message is presented in display 220 of the user's telephone 210, similar to FIG. 1B. However, reply-to field 260 consists of a non-actionable value. Although the value may identify a source of the message (e.g., the txtWeb information service), it is non-actionable because the recipient of the illustrated message cannot respond using the content of field 260.

Therefore, in the illustrated embodiment, text 240 of the message is augmented with address 270 (e.g., a telephone number) of the source of the message (i.e., the information service provider). The user need not search for a valid address in order to respond to the message, thereby making the experience of using the information service more enjoyable.

Embodiments of the invention described herein can be applied in environments in which messages are relatively limited in length (e.g., 160 characters) and environments that are more liberal (e.g., hundreds of characters).

Advantageously, the address that is inserted will be compatible with the target user's aggregator (or telephone service provider). In particular, for target users serviced by different aggregators, different addresses may be inserted in messages to those users. Where multiple possible aggregators may be able to service a user, or multiple addresses could be used by the target user to reach the information service via his or her aggregator, an address may be chosen that corresponds to the cheapest and/or fastest service.

In some embodiments of the invention, an issuer or originator of text messages to users may be required to receive approval or an “opt-in” from a user before it can continue sending messages to that user. Because an embodiment of the invention may be used in an environment in which telephonically exchanged electronic text is a (primary means of communication between the issuer and the user, sending an entire contract or agreement or terms of service to the user, before the user can do anything else, may deter the user from using the issuer's services. Having to view the entire agreement on the tiny display screen of his phone may frustrate him to the point of avoiding the service.

In these embodiments, when it is determined that a particular user has not yet opted into the issuer's service, a summary terms of service message is sent to the user. The user may also be advised that if he or she submits another request, query or other message to the issuer, the user will be deemed to have opted into the service agreement described in the summary terms of service.

If required by regulation and/or if requested by the user, a full copy of the service agreement or terms of service may be sent to the user, by text to his telephone and/or to another destination by other means (e.g., via electronic mail to a computer).

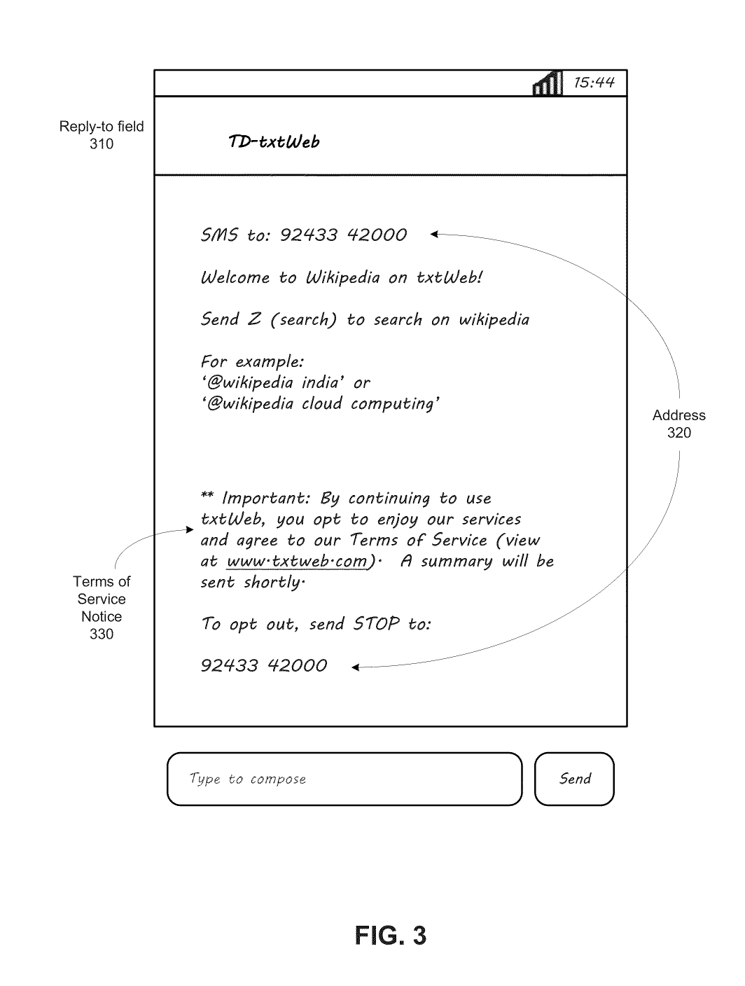

FIG. 3 is a block diagram illustrating an electronic message delivered to a user, according to some embodiments of the invention. In these embodiments, an information service or server responds to user needs by issuing the users text messages containing desired or useful information.

The message shown in FIG. 3 includes reply-to field 310 that, because of law, regulation or other restriction, consists of a non-actionable value. A user cannot respond directly to the information service by using the content of field 310.

However, the body of the message includes not only information for the user (e.g., tips on using the information service to receive Wikipedia information), but also address 320. Unlike the content of reply-to field 310, address 320 is actionable, in that a user can send a message to the address.

Multiple different addresses may be embedded in the body of the message. For example, a first address may be provided for issuing a new or follow-on information request, a different address may be provided for opting-out or cancelling the service, and so on.

Depending on the configuration of the user's telephone, it may be able to recognize a telephone number within the message, such as address 320, and make it even easier for the user to direct a new message or a response to that number. For example, the message could be scanned by an application or utility executing on the telephone, recognize the address as a telephone number and offer the user the option of responding to the address.

Also in FIG. 3, terms of service notice 330 is appended to the message because the information service determined that the user to whom the message of FIG. 3 was directed has not yet opted-in to the service. Therefore, the user is notified that he or she will be deemed to have opted-in if he or she sends another request (or response) to the service.

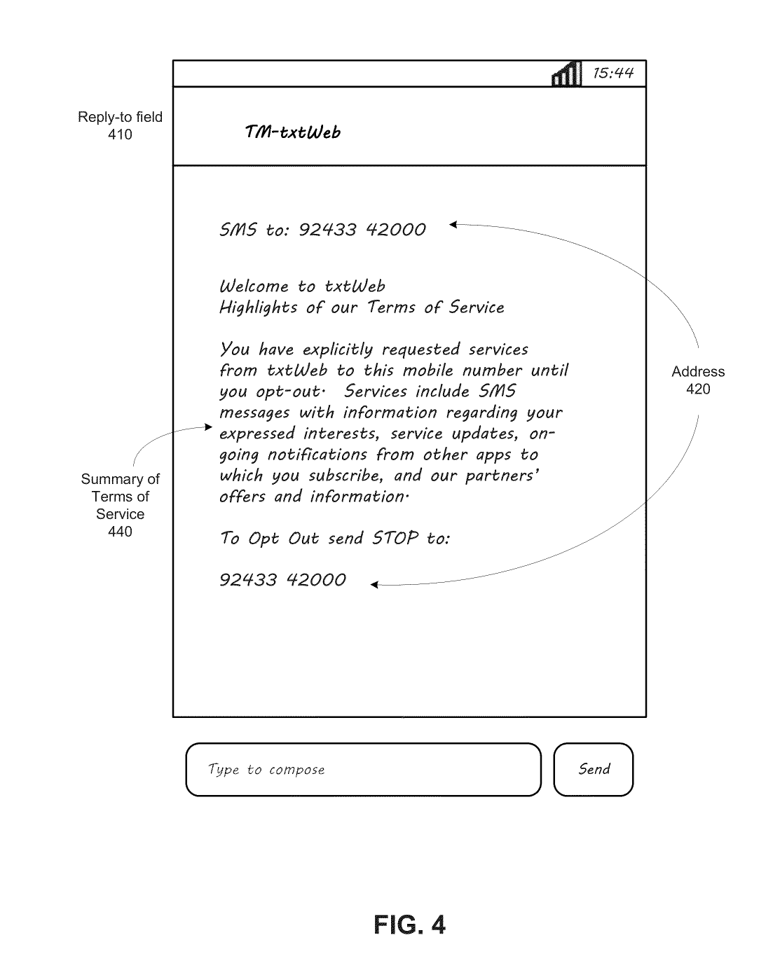

FIG. 4 illustrates a message that may follow the message of FIG. 3, according to some embodiments of the invention. Because the user had not yet opted-in to the information service, the service may send the illustrated summary of the terms of service as a separate message. Alternatively, the summary may be appended to a previous message, depending on the length of summary 440 and maximum length of a message that can be delivered. It may be noted that an actionable address (address 420) is again included in the body of the message, because reply-to field 410 consists of a non-actionable value.

A user of a text information provider service (or other service) may subscribe to or indicate a desire to subscribe to a “push”-type of action, wherein the information provider sends information to the user without a specific request (e.g., because the information matches an interest previously expressed by the user). However, if the user is included in a Do-Not-Call registry, a National Customer Preference Register (NCPR) or other similar registry, and there is no explicit opt-in from the user, the service may be required to refrain from pushing communications to the user. In such a situation, in response to a specific request from the user, the service may remind or notify the user that it cannot push the user's desired information and explain why.

Some embodiments of the invention may be implemented as back-up or fall-back to some other form or method of communication with a user. For example, a user may engage in an interactive data exchange with a web server or other service from her computer or smart phone by operating a browser), and the data connection may be broken because a Wi-Fi connection or a physical cable fails, or for some other reason. The service may then fall-back to providing the user with requested information via SMS messages.

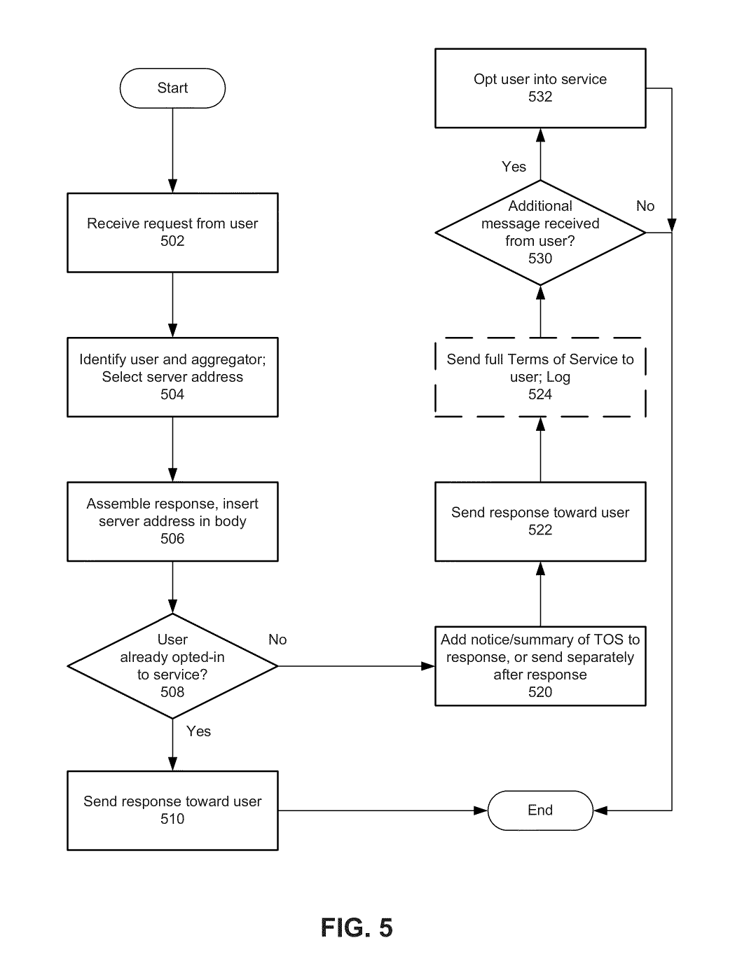

FIG. 5 is a flow chart demonstrating a method of electronic text communication with a user, according to some embodiments of the invention. These embodiments are described as they may be implemented by an electronic information service that delivers information via text message, but may be readily modified for other implementations, as will be understood by one of ordinary skill in the art.

In operation 502, a request is received from a user. Illustratively, the request may be an SMS text message sent from the user's telephone. The request includes a set of keywords, a description or some other text indicating what information the user desires.

In operation 504, the information service identifies the user (e.g., by telephone number) and the aggregator (or telephone service provider) that services the user. Further, the service will determine which address (e.g., telephone number) the user should use to send a message or response to the information service (e.g., in case he wants to reply to the service's response to the user's request or make another request). The selected address will be compatible with the user's aggregator, meaning that the address is part of the aggregator's network or that a message sent by the user to the address is deliverable by the aggregator without having to also use another aggregator's services.

If the user could use any of multiple information service addresses, the selected address may be the one that will cost the user the least amount of money in terms of fees charged by her aggregator. For example, address selection may be based on the user's location, so that SMS fees incurred by the user are minimized (e.g., a local reply number instead of a long-distance number). Address selection may also consider a user's preferences.

In some implementations, when multiple valid addresses could be provided to users of a given aggregator, they may be distributed among the addresses. This may provide a form of load-balancing, so that all requests from the users are not delivered to one address or one physical computer server.

Once an address is provided to a user within a text message, that same address may always be employed for that user. This will alleviate the need to determine, every time a message is to be sent, which address to use. If, however, the user's aggregator or service provider changes, a new address may be associated with her.

In operation 506, the information service processes the user's request, retrieves responsive information, assembles a response and augments the response with the selected information service address. The address may be injected any number of times (i.e., one or more) into the body of the response message, such as just at the top or just at the bottom, at or near both the top and bottom, at intervals such that it appears multiple times as the user scrolls through the message body, etc.

In operation 508, the service determines whether the user has already opted-in to the information service. If not, the method advances to operation 520. Otherwise, the method continues at operation 510.

In operation 510, the information service dispatches the response message toward the user, via her aggregator. As described above, it will be delivered with a non-actionable reply-to field that cannot be replied to, but with an actionable address embedded in the message. After operation 510, the illustrated method ends.

In operation 520, because the user has not yet opted-in to the information service, a notice and/or summary of a terms of service (TOS), a service agreement or some other agreement are added to the response appended to the end of the body). Illustratively, the notice may advise the user that further interaction with the system will automatically opt the user into the terms of service. The summary includes some of the important points of the terms of service, such as what the user may receive from the service, what the service may do with the user's information, etc.

In some alternative embodiments of the invention, the summary may be sent separately from the response message. For example, the maximum length of a text message may not allow it to be included with the response. Or, if the full terms of service are fairly short, they may be sent in place of a summary.

In operation 522, the information service's response to the user's request is dispatched toward the user, via her aggregator.

In operation 524, in some implementations, the summary terms of service may be followed by the full terms of service or service agreement, especially if required by regulation or requested by the user. The message may be logged so that if the message is determined to be undeliverable, the TOS can be sent again. Full terms may be sent to the user's telephone and/or other destination (e.g., a computer email account).

In operation 530, the service determines whether another message is received from the user. If so, the method advances to operation 532; otherwise, the method ends (e.g., the user may have opted-out of the service).

In operation 532, the user's additional interaction with the information service allows it to treat the user as having opted-in to the service. After operation 532, the illustrated method ends, or may return to some other operation (e.g., operation 506) if the user's additional interaction comprises another information request.

In some embodiments of the invention, delivery of terms of service or a service agreement may be tracked. If delivery cannot be verified (e.g., within a particular period of time), a retry mechanism may be initiated to re-send them.

In some embodiments of the invention, a mobile device user or user account may be in any of multiple states regarding an opt status with the information service (or other originator of text messages). For example, the user is in an “opt-out” state if he opted out of the service, either explicitly (e.g., via a STOP message) or implicitly (e.g., by never revisiting the service after being notified of the terms of service. A user is in an “opt-in” state after he opts-in to the service (e.g., by returning the service after receiving a terms of service notice).

A user is in an “opt-transition” state after the terms of service notice was provided to him (and/or summary or full terms of service). If he returns, he has opted-in; if not, his state may change to opt-out after some time period. If the notice (or summary or full terms) is deemed not to have been delivered (e.g., the message delivery failed), it may be re-sent.

In embodiments of the invention reflected in FIG. 5, a threshold determination is made when a user request is received, as to whether a normal (or actionable) value may be used in the reply-to field of a message to the user, or whether a modified (or non-actionable) value must be used. Illustratively, a regulation or restriction requiring non-actionable values may not apply to requests from some users, depending on their location (e.g., another state or country), their familiarity with the information service, whether they have approved receiving an actionable reply-to value versus a descriptive value, etc. If the restriction does not apply to the user request, a message may be sent to the user without being augmented as described herein, unless the user has not yet opted-in to the service, in which case the relevant portions of the illustrated method may be applied.

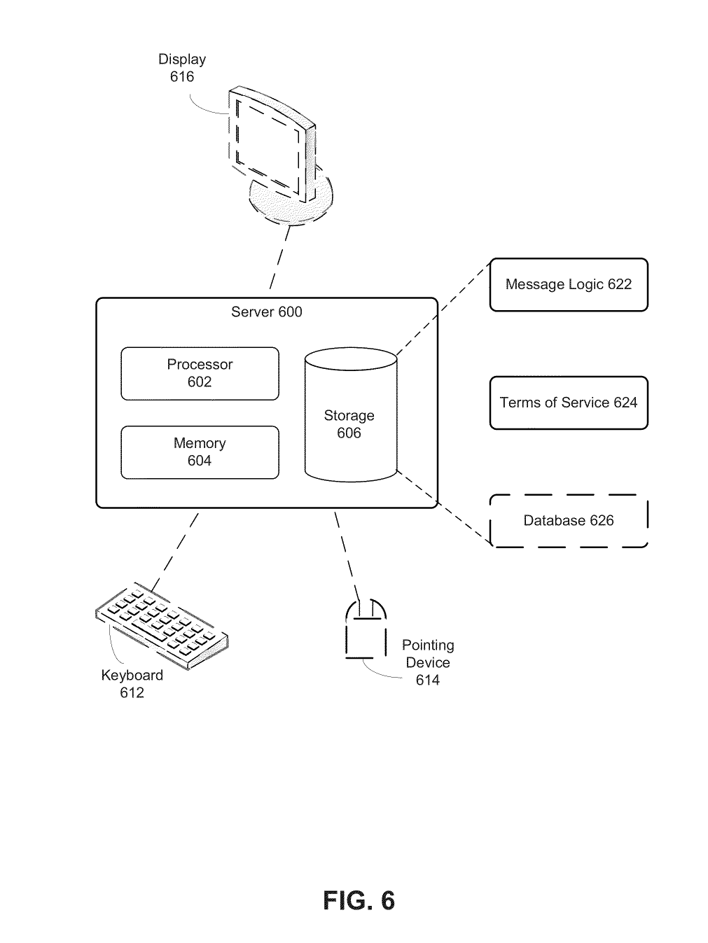

FIG. 6 is a block diagram of a system for electronic text communication with a user, according to some embodiments of the invention.

Server 600 of FIG. 6 (e.g., an information server) comprises processor 602, memory 604 and storage 606, which may comprise one or more optical and/or magnetic storage components. Server 600 may be coupled (permanently or transiently) to keyboard 612, pointing device 614 and display 616.

Storage 606 of the server stores logic that may be loaded into memory 604 for execution by processor 602. Such logic includes message logic 622, which comprises processor-executable instructions for receiving, processing, generating and transmitting SMS, MMS and/or other types of electronic communications.

Logic 622 may be configured to populate a reply-to field with actionable or non-actionable data, or this data may be injected by another entity (e.g., an aggregator, a message processor or gateway). Logic 622 may also determine an address of the server to be embedded in the text of a message sent to a user. Logic 622 and/or other logic stored in storage 606 may also be executable to perform load-balancing of the servicing of user requests among multiple addresses of server 600.

Storage 606 also stores terms of service 624 (or a service agreement or similar document) regarding the use of services offered by server 600, a notice regarding such terms, and/or a summary of such terms, as described above.

Storage 606 further includes database 626, which may store user data (e.g., names, telephone numbers, opt status), aggregator data, telephone numbers of server 600 to use for different aggregators, etc.

The environment in which some embodiments of the invention are executed may incorporate a general-purpose computer or a special-purpose device such as a hand-held computer. Details of such devices (e.g., processor, memory, data storage, display) may be omitted for the sake of clarity.

The data structures and code described in this detailed description are typically stored on a computer-readable storage medium, which may be any device or medium that can store code and/or data for use by a computer system. The computer-readable storage medium includes, but is not limited to, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules may include, but are not limited to, application-specific integrated circuit (ASIC) chips, field-programmable gate arrays (FPGAs) and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. A method of electronic text communication, comprising:
receiving a first request from a user at a server, via a telephone service provider;
composing a first electronic text message response to include a numerical address of the server to which the telephone service provider is able to deliver requests from users, including the first request; and
transmitting the first electronic text message response toward the user;
wherein the first electronic text message response is required to be delivered to the user with a reply-to field not consisting of the numerical address.

2. The method of claim 1, wherein said composing comprises placing the numerical address in a body of the electronic text message response in addition to information responsive to the first request.

3. The method of claim 1, further comprising, prior to said composing:
identifying multiple numerical addresses of the server to which the telephone service provider is able to deliver requests from users; and
selecting the numerical address from the multiple numerical addresses so as to load-balance the requests from users among the multiple numerical addresses.

4. The method of claim 1, further comprising, prior to said composing:
identifying multiple numerical addresses of the server to which the telephone service provider is able to deliver requests from the user; and
selecting the numerical address from the multiple numerical addresses based on one or more of:
a location of the user; and
a preference of the user.

5. The method of claim 1, wherein the numerical address is a telephone number.

6. The method of claim 1, wherein said composing further comprises:
including in the first electronic text message response a notice regarding terms of service of the server;
wherein said notice does not comprise the terms of service.

7. The method of claim 6, wherein said notice advises the user that the user will be deemed to have accepted the terms of service if the user submits another request to the server.

8. The method of claim 6, further comprising:
transmitting a summary of the terms of service toward the user.

9. The method of claim 6, further comprising:
if another request is received from the user, recording acquiescence of the user with the terms of service.

10. The method of claim 1, wherein the numerical address was usable by the telephone service provider to deliver requests from users before said receiving a first request.

11. A non-transitory processor-readable medium storing instructions that, when executed by a processor, cause the processor to perform a method of electronic text communication, comprising:
receiving a first request from a user at a server, via a telephone service provider;
composing a first electronic text message response to include a numerical address of the server to which the telephone service provider is able to deliver requests from users, including the first request; and
transmitting the first electronic text message response toward the user;
wherein the first electronic text message response is required to be delivered to the user with a reply-to field not consisting of the numerical address.

12. A method of providing information to a user with an actionable identifier of the source of the information, the method comprising:
receiving a first electronic request message at an information server from a user via an aggregator;
determining whether the user has opted-in to terms of service of the information server;
composing an electronic response to the first electronic request message, to include a destination address of the information server corresponding to the aggregator;
if the user has not opted-in to the terms of service, appending a terms of service notice to the electronic response; and
transmitting the electronic response toward the user via the aggregator;
wherein the response is automatically delivered with a non-actionable reply-to field to which the user cannot reply.

13. The method of claim 12, further comprising:
if another electronic message is received from the user, opting the user into the terms of service of the information server.

14. The method of claim 12, further comprising, if the user has not opted-in to the terms of service:
transmitting a summary terms of service of the information server toward the user.

15. The method of claim 14, wherein the summary terms of service are appended to the electronic response.

16. The method of claim 12, further comprising:
choosing the destination address from multiple valid destination addresses of the information server by:
selecting a subset of the multiple valid destination addresses that are compatible with the aggregator; and
selecting the destination address by applying a scheme to load-balance electronic request messages delivered to the information server by the aggregator among the subset of the multiple valid destination addresses.

17. A system for exchanging electronic text communications with a user, the system comprising:
a processor;
communication connections with one or more telephone service providers, through which electronic text messages can be exchanged;
a database storing data regarding a first user, including a first address of the system to which the first user may direct electronic text messages via a first telephone service provider that services the first user; and
message logic executable by the processor to generate a first electronic text message to the first user, wherein the first electronic text message comprises:
the first address of the system; and
a reply-to field consisting of information other than the first address.

18. The system of claim 17, further comprising:
terms of service of the system;
wherein the message logic is further executable by the processor to include in the first electronic text message one or more of:
a notice regarding the terms of service; and
a summary of the terms of service.

19. The system of claim 17, further comprising:
logic executable by the processor to load-balance electronic requests directed to the system among multiple addresses of the system, including the first address.

20. The system of claim 17, further comprising logic executable by the processor to:
verify delivery to the first user of terms of service of the system; and
resend the terms of service to the first user if the delivery cannot be verified.
